(19) United States
(12) Patent Application Publication
(10) Pub. No.: US 2025/0283807 A1
(43) Pub. Date: Sep. 11, 2025

(54) OPTICAL WAVEGUIDE SENSOR

(71) Applicant: FURUKAWA ELECTRIC CO., LTD., Tokyo (JP)

(72) Inventors: Noritaka MATSUBARA, Tokyo (JP); Kanji TANAKA, Tokyo (JP); Atsushi IZAWA, Tokyo (JP)

(73) Assignee: FURUKAWA ELECTRIC CO., LTD., Tokyo (JP)

(21) Appl. No.: 19/215,491

(22) Filed: May 22, 2025

Related U.S. Application Data
(63) Continuation of application No. PCT/JP2024/037273, filed on Oct. 18, 2024.

(30) Foreign Application Priority Data
Oct. 20, 2023 (JP) 2023-181432

(51) Int. Cl. G01N 21/31

(52) U.S. Cl. CPC G01N 21/31; G01N 2201/08

(57) ABSTRACT

An optical waveguide sensor includes: a plurality of first waveguides, each first waveguide including a core at least partially enclosed by a cladding and being configured to guide an examination light; and a contact surface with which an examination subject is in contact and from which leaks seeping component of the examination light guided by the first waveguides. The examination light guided by the plurality of first waveguides has mutually different amount of leakage from the contact surface.

### CROSS-REFERENCE TO RELATED APPLICATIONS

This application is a continuation of International Application No. PCT/JP2024/037273, filed on Oct. 18, 2024 which claims the benefit of priority of the prior Japanese Patent Application No. 2023-181432, filed on Oct. 20, 2023, the entire contents of which are incorporated herein by reference.

### BACKGROUND OF THE INVENTION

### 1. Field of the Invention

The present disclosure relates to an optical waveguide sensor.

### 2. Description of the Related Art

In the related art, a sensor is known that measures the components or the concentration of a material using the ATR method (ATR stands for Attenuated Total Reflection) (for example, Japanese Patent Application Laid-open No. 2005-61904). When there occurs total reflection of infrared light inside an ATR crystal prism, the specimen that is making contact with the prism can be examined by the sensor using the light that sparsely seeps to the outside of the prism (i.e., the evanescent light).

### SUMMARY OF THE INVENTION

In such types of sensors, for example, if the examination accuracy can be further enhanced, it would prove beneficial.

In that regard, it is desirable to provide a new and improved optical waveguide sensor that, for example, enables achieving further enhancement in the examination accuracy.

In some embodiments, an optical waveguide sensor includes: a plurality of first waveguides, each first waveguide including a core at least partially enclosed by a cladding and being configured to guide an examination light; and a contact surface with which an examination subject is in contact and from which leaks seeping component of the examination light guided by the first waveguides. The examination light guided by the plurality of first waveguides has mutually different amount of leakage from the contact surface.

In some embodiments, an optical waveguide sensor includes: a plurality of first waveguides, each first waveguide including a core at least partially enclosed by a cladding and being configured to guide an examination light; and a contact surface with which an examination subject is in contact and from which leaks seeping component of the examination light guided by the first waveguides. The contact surface includes a first contact surface corresponding to each of the first waveguides.

In some embodiments, an optical waveguide sensor includes: a plurality of first waveguides, each first waveguide including a core at least partially enclosed by a cladding and being configured to guide an examination light; a contact surface with which an examination subject is in contact and from which leaks seeping component of the examination light guided by the first waveguides; and an identification structure that enables visual identification of the contact surface.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an illustrative and schematic planar view diagram of an optical waveguide sensor according to a first embodiment;

FIG. 2 is a cross-sectional view of an II-II position in the optical waveguide sensor illustrated in FIG. 1;

FIG. 3 is a cross-sectional view at an IIIa-IIIa position and an IIIb-IIIb position in the optical waveguide sensor illustrated in FIG. 1;

FIG. 4 is a diagram illustrating an example of the regression analysis of a parameter and the loss intensity of the detection result obtained by the optical waveguide sensor according to the first embodiment;

FIG. 5 is an illustrative and schematic planar view diagram of an optical waveguide sensor according to a second embodiment;

FIG. 6 is a VI-VI cross-sectional view of the optical waveguide sensor illustrated in FIG. 5;

FIG. 7 is a VII-VII cross-sectional view of the optical waveguide sensor illustrated in FIG. 5;

FIG. 8 is an illustrative and schematic planar view diagram of an optical waveguide sensor according to a third embodiment;

FIG. 9 is cross-sectional view at an IXa-IXa position and an IXb-IXb position of the optical waveguide sensor illustrated in FIG. 8;

FIG. 10 is an illustrative and schematic planar view diagram of an optical waveguide sensor according to a fourth embodiment;

FIG. 11 is an illustrative and schematic planar view diagram of an optical waveguide sensor according to a fifth embodiment;

FIG. 12 is an XII-XII cross-sectional view of the optical waveguide sensor illustrated in FIG. 11;

FIG. 13 is an XIII-XIII cross-sectional view of the optical waveguide sensor illustrated in FIG. 11;

FIG. 14 is an illustrative and schematic planar view diagram of an optical waveguide sensor according to a sixth embodiment;

FIG. 15 is an illustrative and schematic planar view diagram of some part of an optical waveguide sensor according to a seventh embodiment;

FIG. 16 is an illustrative and schematic planar view diagram of an optical waveguide sensor according to an eighth embodiment;

FIG. 17 is an illustrative and schematic planar view diagram of an optical waveguide sensor according to a ninth embodiment;

FIG. 18 is an illustrative and schematic planar view diagram of an optical waveguide sensor according to a 10-th embodiment;

FIG. 19 is an illustrative and schematic planar view diagram of an optical waveguide sensor according to an 11-th embodiment;

FIG. 20 is an illustrative and schematic planar view diagram of an optical waveguide sensor according to a 12-th embodiment;

FIG. 21 is an illustrative and schematic planar view diagram of an optical waveguide sensor according to a 13-th embodiment;

FIG. 22 is an illustrative and schematic planar view diagram of an optical waveguide sensor according to a 14-th embodiment;

FIG. 23 is a diagram illustrating an example of the regression analysis of a parameter and the loss intensity of the detection result obtained by the optical waveguide sensor according to the 14-th embodiment; and

FIG. 24 is an illustrative and schematic cross-sectional view, at an equivalent position to FIG. 3, of an optical waveguide sensor according to a modification example of the first embodiment.

### DETAILED DESCRIPTION OF THE PREFERRED EMBODIMENTS

Exemplary embodiments of the disclosure are described below. The configurations explained in the embodiments described below as well as the actions and the results (effects) attributed to the configurations are only exemplary. Thus, the disclosure can be implemented also using some different configuration than the configurations disclosed in the embodiments described below. Meanwhile, according to the disclosure, it becomes possible to achieve at least one of various effects (including secondary effects) that are attributed to the configurations.

The embodiments described below include identical constituent elements. Thus, based on the identical configuration according to each embodiment, it becomes possible to achieve identical actions and identical effects. In the following explanation, the identical constituent elements are referred to by the same reference numerals, and their explanation is not given in a repeated manner.

The drawings are schematic diagrams, and the dimensions illustrated in the drawings are sometimes different than the dimensions of the actual objects. In the drawings, the X direction is indicated by an arrow X, the Y direction is indicated by an arrow Y, and the Z direction is indicated by an arrow Z. The X direction, the Y direction, and the Z direction intersect with each other and are orthogonal to each other. In the present written description, the planar view indicates the line of sight viewed from the opposite direction of the Z direction, and is a planar view diagram represents a diagram in the planar view.

### First Embodiment

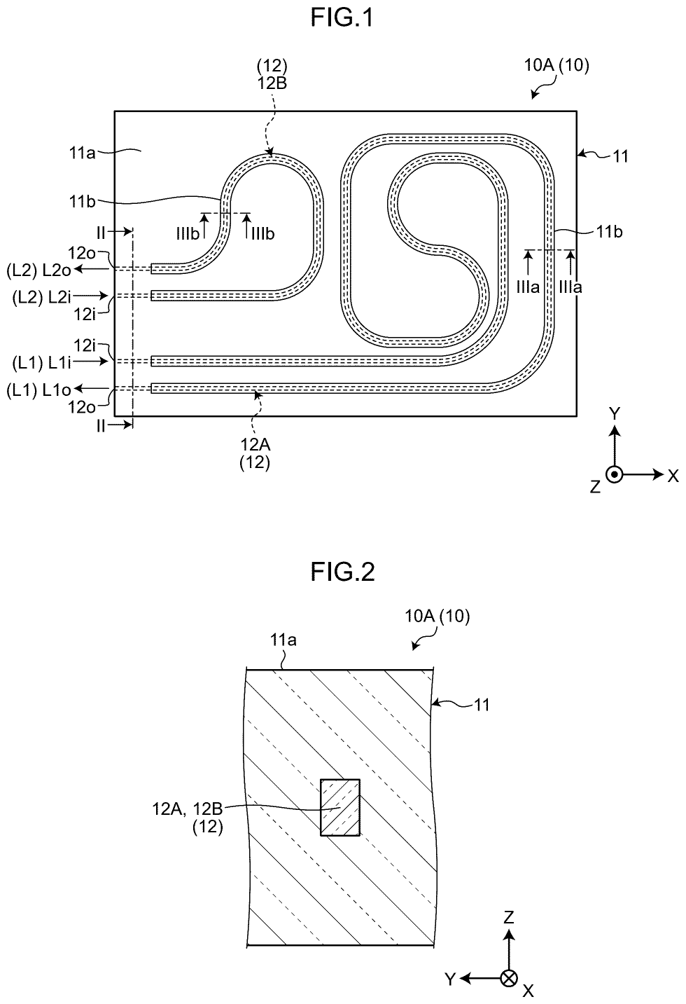

FIG. 1 is a planar view diagram of an optical waveguide sensor 10A (10) according to a first embodiment. For example, the optical waveguide sensor 10 has a relatively thinner and flattened cuboid shape in the Z direction. At the end portion of the optical waveguide sensor 10 in the Z direction, a surface 11a is present that surfaces the Z direction, that intersects with the Z direction, and that is substantially orthogonal to the Z direction. Herein, the Z direction represents an example of a first direction, and the surface 11a represents an example of a first surface.

The optical waveguide sensor 10 can be configured as, for example, a known planar lightwave circuit (PLC). In that case, the optical waveguide sensor 10 includes, in an integrated manner, a substrate that expands to intersect with the Z direction and a structure that is laminated on the substrate in the Z direction. The substrate is a glass substrate or a silicon substrate. The structure on the substrate includes cores 12 and a cladding 11 that encloses the cores 12. The cladding 11 is made of, for example, a silica based glass material containing SiO₂; and the cores 12 are made of a silica based glass material having higher refractive index than the refractive index of the cladding 11.

In the optical waveguide sensor 10, the cores 12 transmit an examination light. Accompanying the transmission of the examination light; the seeping component of the examination light, that is, the evanescent light gets distributed in those portions of the cladding 11 which are in the vicinity of the cores 12. Herein, the cores 12 represent an example of waveguides (first waveguides).

As illustrated in FIG. 1, the optical waveguide sensor 10 includes a plurality of cores 12 (12A and 12B), that is, includes a plurality of waveguides. Each core 12 extends in a curved manner and substantially along a virtual surface intersecting with the Z direction. An examination light L1 that is input to an inlet end 12i of the core 12A is transmitted along the core 12A, and is output from an outlet end 12o of the core 12A. Similarly, an examination light L2 that is input to the inlet end 12i of the core 12B is transmitted along the core 12B, and is output from the outlet end 12o of the core 12B. In the first embodiment, L1i represents the incident light of the examination light L1, and L1o represents the outgoing light of the examination light L1. Similarly, L2i represents the incident light of the examination light L2, and L2o represents the outgoing light of the examination light L2.

As illustrated in FIG. 1, in the first embodiment, the core 12A and the core 12B have mutually different lengths, and the length of the core 12A is greater than the length of the core 12B.

FIG. 2 is a cross-sectional view of an II-II position in the optical waveguide sensor 10A illustrated in FIG. 1. At the II-II position, in the surrounding portion of the core 12A as well as the surrounding portion of the core 12B, the optical waveguide sensor 10A has the cross-sectional shape illustrated in FIG. 2, that is, has the identical cross-sectional shape. Moreover, in the first embodiment, between the inlet end 12i and the outlet end 12o, each core 12 has the same cross-sectional shape as the shape illustrated in FIG. 2.

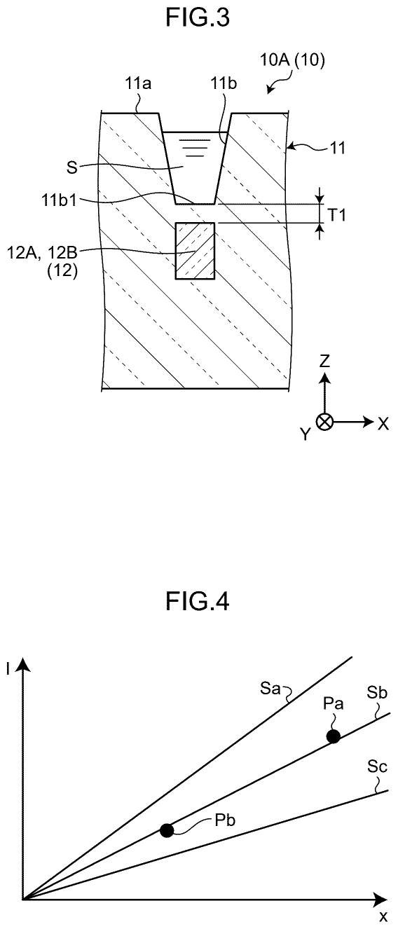

FIG. 3 is a cross-sectional view at an IIIa-IIIa position and an IIIb-IIIb position in the optical waveguide sensor 10A illustrated in FIG. 1. In the surrounding portion of the core 12A as well as the surrounding portion of the core 12B, the optical waveguide sensor 10A has the cross-sectional shape illustrated in FIG. 3, that is, has the identical cross-sectional shape. Meanwhile, in the first embodiment, although the cores 12 (12 and 12B) have a quadrangular cross-sectional shape as an example, that is not the only possible case. Thus, the cross-sectional shape can be any other shape other than the quadrangular shape.

As illustrated in FIG. 3, in the optical waveguide sensor 10, recesses 11b are formed that are recessed in the opposite direction to the Z direction from the surface 11a toward the cores 12. In the optical waveguide sensor 10, as illustrated in FIG. 1, the recesses 11b are formed at a total of two positions corresponding to the cores 12A and 12B. The two recesses 11b are disposed to overlap with the cores 12A and 12B in the Z direction, and extend along the corresponding cores 12A and 12B in the entire section excluding the vicinity of the inlet end 12i and the outlet end 120. Moreover, the recesses 11b extend, in the respective entire sections, in the cross-sectional shape illustrated in FIG. 3, that is, extend with a substantially constant width and a substantially constant depth. A bottom surface 11b1 of each recess 11b is a flat surface that is oriented toward the Z direction, that intersects with the Z direction, and that expands in the substantially orthogonal direction to the Z direction. Each bottom surface 11b1 substantially overlaps with the corresponding core 12 in the Z direction. Moreover, each bottom surface 11b1 has the substantially same width as the width of the corresponding core 12. However, that is not the only possible case. Thus, the width of each bottom surface 11b1 can be greater or smaller than the width of the corresponding core 12. Moreover, the width of the bottom surfaces 11b1 is substantially constant along the longitudinal direction of the corresponding recesses 11b. However, that is not the only possible case. Alternatively, the bottom surfaces 11b1 can have locally different widths in different portions.

In such a configuration, an examination subject S is placed inside each recess 11b. The examination subject S is, for example, a liquid, a gas, a fluid, a viscoelastic object, or a solid object having flexibility. As explained above, in the portions of the cladding 11 that surround the cores 12, the evanescent light of the examination lights L1 and L2 gets distributed. In between each core 12 and the corresponding bottom surface 11b1 of the recess 11b, a thickness T1 of the cladding 11 is relatively smaller such as equal to or smaller than 5 [μm]. When the thickness T1 is smaller than the mode field radius of the examination lights L1 and L2 passing through the cores 12, the mode field of the examination lights L1 and L2 spreads out more toward the inside of the recesses 11b than toward the bottom surfaces 11b1 thereof. Hence, the evanescent light of the examination lights L1 and L2 leaks from the bottom surfaces 11b1 of the recesses 11b, and gets absorbed in the examination subject S. In that case, the intensity of the intensity lights L1o and L2o decreases with respect to the intensity of the incident lights L1i and L2i by the amount equivalent to the amount of absorption of the examination lights L1 and L2 by the examination subject S. The amount of decrease (the loss intensity) of the outgoing lights L1o and L2o with respect to the incident lights L1i and L2i, that is, the amount of absorption differs according to the examination subject S. Hence, measuring the loss intensity enables identification of the examination subject S. Each bottom surface 11b1 represents an example of a contact surface with which the examination subject S is in contact, and each recess 11b represents an example of a receiving recess and a first recess. Moreover, the thickness T1 represents an example of the distance from the cores 12A and 12B to the bottom surfaces 11b1. In the cross-sectional surface illustrated in FIG. 2, since the cladding 11 around the cores 12A and 12B is thick, there is no leakage of the evanescent light. Meanwhile, the thickness T1 is equal to or greater than “0” (T1≥0).

As illustrated in FIG. 1, in the two recesses 11b corresponding to the cores 12A and 12B, the bottom surfaces 11b1 have mutually different lengths. As explained earlier, in the two recesses 11b, the bottom surfaces 11b1 have the same width that is substantially constant along the longitudinal direction. Thus, in each of the two recesses 11b, the area of the bottom surface 11b1 becomes equal to (constant width)×(length); and that area differs according to the length, that is, differs in proportion to the length. In the first embodiment, the length of the recess 11b corresponding to the core 12A is greater than the length of the recess 11b corresponding to the core 12B. Hence, the area of the bottom surface 11b1 of the recess 11b corresponding to the core 12A becomes greater than the area of the bottom surface 11b1 of the recess 11b corresponding to the core 12B.

The amount of leakage of the evanescent light from each bottom surface 11b1 differs according to the area of that bottom surface 11b1 and increases in proportion to the area. Thus, in the optical waveguide sensor 10A (10) according to the first embodiment, two waveguides are included that have different amounts of leakage of the evanescent light from the respective bottom surfaces 11b1.

FIG. 4 is a diagram illustrating an example of the regression analysis of a parameter x and a loss intensity I of the detection result obtained by the optical waveguide sensor 10. In the graph illustrated in FIG. 4, the parameter x on the horizontal axis represents the parameter for varying the amount of leakage of the examination light from the waveguide. For example, the parameter x represents the area of the length of the bottom surface 11b1. The loss intensity I on the vertical axis represents the loss intensity of the examination lights L1 and L2 corresponding to the cores 12A and 12B (the waveguides). In FIG. 4 is illustrated the experiment result corresponding to the same examination lights L1 and L2. In the graph, a point Pa represents the coordinates of the measurement result of the parameter x and the loss intensity I corresponding to the core 12A, and a point Pb represents the coordinates of the measurement result of the parameter x and the loss intensity I corresponding to the core 12B. The bottom surface 11b1 of the recess 11b corresponding to the core 12A has a greater area (or a greater length) than the area (or the length) of the bottom surface 11b1 of the recess 11b corresponding to the core 12B. Hence, the value of the parameter x at the point Pa is greater than the value of the parameter x at the point Pb. Moreover, greater the value of the parameter x, the greater becomes the loss intensity I. Hence, the loss intensity I at the point Pa is greater than the loss intensity I at the point Pb. In that case, for example, if a function obtained by performing regression analysis of the points Pa and Pb is compared with a function of the parameter x and the loss intensity I of each of known materials Sa to Sc, it becomes possible to identify whether the examination subject S is same as any one of the materials Sa to Sc or to figure out the material from among the materials Sa to Sc to which the properties of the examination subject S are close. Meanwhile, in FIG. 4 is illustrated the example in which the parameter x and the loss intensity I are proportional to each other. However, the parameter x need not be proportional to the loss intensity I.

As explained above, the optical waveguide sensor 10A (10) includes two waveguides (first waveguides) that have different amounts of leakage of the evanescent light from the corresponding bottom surfaces 11b1 (contact surfaces). With such a configuration, the two parameters x can be measured and the two loss intensities I corresponding to the parameters x can be measured; regression analysis can be performed, for example, using two combinations of the parameters x and the loss intensities I; and the examination subject S can be identified and the properties of the examination subject S can be figured out. That is, according to the first embodiment, as a result of measuring the loss intensity in each of the two waveguides that have different amounts of leakage of the evanescent light, the examination of the examination subject S can be performed with more accuracy as compared to the case of measuring the loss intensity in only a single waveguide.

Moreover, in the first embodiment, in the optical waveguide sensor 10, the recesses 11b (the receiving recesses) are provided in which the examination subject S is placed, and the bottom surfaces 11b1 of the recesses 11b serve as the contact surfaces onto which the evanescent light leaks. With such a configuration, as compared to a configuration in which no recess is provided, the examination subject S can be held in the measurable state with more ease and more stability.

Moreover, in the first embodiment, in the optical waveguide sensor 10, a plurality of recesses 11b is provided. With such a configuration, for example, mutually different examination subjects S can be placed in the recesses 11b, and the examination can be carried out for the different examination subjects S.

### Second Embodiment

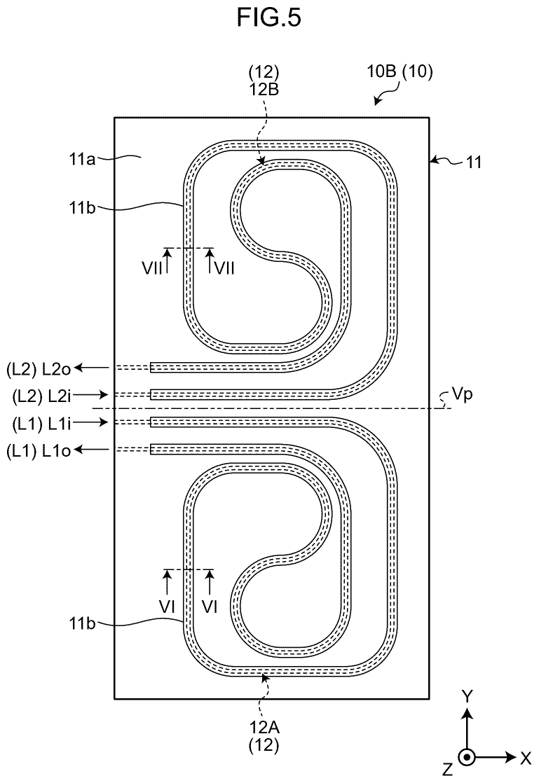

FIG. 5 is a planar view diagram of an optical waveguide sensor 10B (10) according to a second embodiment. As illustrated in FIG. 5, in the second embodiment, two cores 12A and 12B (12) are in the mirror image relationship having plane symmetry with respect to a virtual plane Vp that intersects with the Y direction. Moreover, the recesses 11b that are provided corresponding to the cores 12A and 12B have the same length but have mutually different shapes.

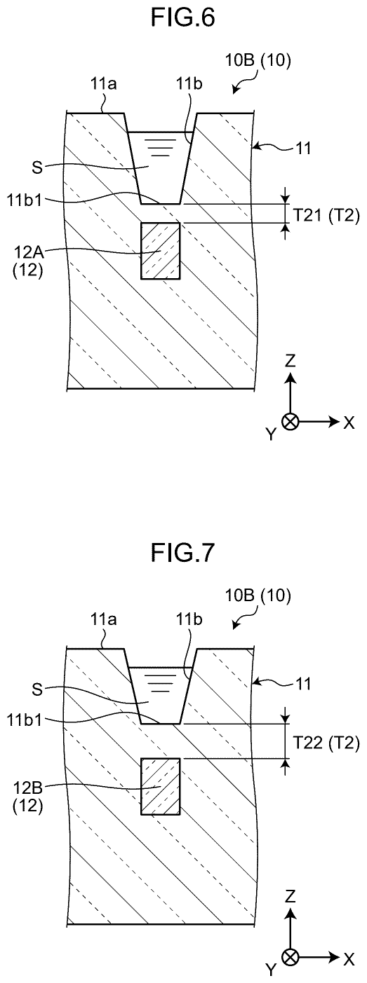

FIG. 6 is a VI-VI cross-sectional view of the optical waveguide sensor 10B illustrated in FIG. 5, and FIG. 7 is a VII-VII cross-sectional view of the optical waveguide sensor 10B illustrated in FIG. 5. In the second embodiment too, in an identical manner to the first embodiment, the recesses 11b corresponding to the cores 12A and 12B extend along the cores 12A and 12B, respectively, with the cross-sectional shapes illustrated in FIGS. 6 and 7, respectively. When FIG. 6 is compared with FIG. 7, it is clear that the depth of the recess 11b (see FIG. 6), which corresponds to the core 12A, from the surface 11a is greater than the depth of the recess 11b (see FIG. 7), which corresponds to the core 12B, from the surface 11a. Accordingly, a thickness T21 (T2, see FIG. 6) between the core 12A and the bottom surface 11b1 of the recess 11b is smaller than a thickness T22 (T2, see FIG. 7) between the core 12B and the bottom surface 11b1 of the recess 11b. Hence, the amount of leakage of the evanescent light from the bottom surface 11b1 in the optical waveguide including the core 12A is greater than the amount of leakage of the evanescent light from the bottom surface 11b1 in the optical waveguide including the core 12B. That is, in the second embodiment too, the optical waveguide sensor 10B (10) includes two waveguides having different amounts of leakage of the evanescent light from the corresponding bottom surfaces 11b1. Thus, in the second embodiment, by treating the thicknesses T2 (T21 and T22) as the parameters x, regression analysis can be performed in an identical manner to the first embodiment as illustrated in FIG. 4. The thicknesses T2 (T21 and T22) represent examples of the distances from the cores 12A and 12B to the corresponding bottom surfaces 11b1.

In this way, in the second embodiment too, the optical waveguide sensor 10B (10) includes two waveguides (first waveguides) that have different amounts of leakage of the evanescent light from the corresponding bottom surfaces 11b1 (contact surfaces). Thus, in the second embodiment too, as a result of measuring the loss intensity in each of the two waveguides, the examination of the examination subject S can be performed with more accuracy as compared to the case of measuring the loss intensity in only a single waveguide.

### Third Embodiment

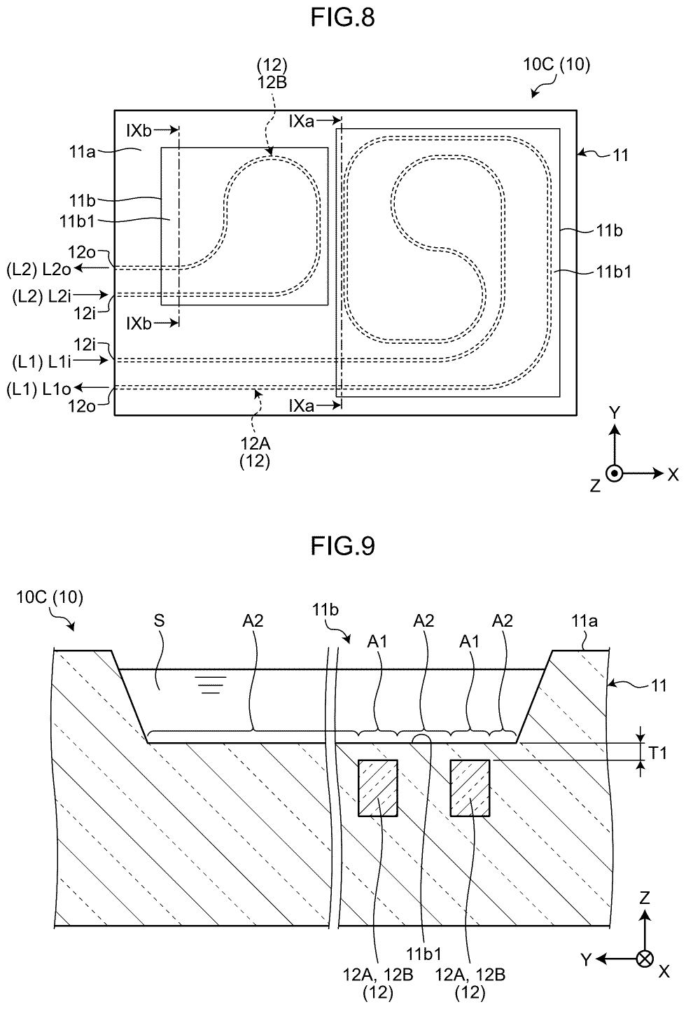

FIG. 8 is a planar view diagram of an optical waveguide sensor 10C (10) according to a third embodiment. When FIG. 8 is compared with FIG. 1, it is clear that the optical waveguide sensor 10C according to the third embodiment includes the cores 12A and 12B (12) having the same shape as in the optical waveguide sensor 10A according to the first embodiment.

However, as illustrated in FIG. 8, in the third embodiment, unlike the recesses 11b extending in an elongated manner along the cores 12A and 12B according to the first and second embodiments described above, the recesses 11b are formed to be wider than the cores 12A and 12B and have a rectangular shape in the planar view.

FIG. 9 is cross-sectional view at an IXa-IXa position and an IXb-IXb position of the optical waveguide sensor 10C illustrated in FIG. 8. At the IXa-IXa position and the IXb-IXb position, in the optical waveguide sensor 10C, although the recesses 11b and the bottom surfaces 11b1 have a different size, the cross-sectional shape is identical as illustrated in FIG. 9. As illustrated in FIG. 9, the recesses 11b and the bottom surfaces 11b1 are wider than the cores 12A and 12B in the Y direction. That is, the bottom surface 11b1 includes first areas A1 that overlap with the cores 12A and 12B in the Z direction, and includes second areas A2 that do not overlap with the cores 12A and 12B in the Z direction but are positioned adjacent to the first areas A1. In the third embodiment too, in an identical manner to the first embodiment, the thickness T1 between the cores 12 and the corresponding bottom surfaces 11b1 is relatively smaller such as equal to or smaller than 5 [μm]. Thus, in the third embodiment, of the bottom surfaces 11b1, the evanescent light leaks mainly from the first areas A1. Herein, the first areas A1 represent examples of a contact surface.

The optical waveguide sensor 10C is configured in such a way that, in the portions in which the cores 12A and 12B overlap with the recesses 11b, the cross-sectional shape is identical to FIG. 9. Hence, in the third embodiment, of the cores 12A and 12B, the evanescent light leaks from the sections overlapping with the recesses 11b. As illustrated in FIG. 8, the length of the section in which the core 12A overlaps with the corresponding bottom surface 11b1 (hereinafter, referred to as a first section) is different than the length of the section in which the core 12B overlaps with the corresponding bottom surface 11b1 (hereinafter, referred to as a second section). In the third embodiment, as an example, the length of the first section is greater than the length of the second section. Thus, in the third embodiment, the amount of leakage of the evanescent light from the bottom surface 11b1 in the waveguide including the core 12A is greater than the amount of leakage of the evanescent light from the bottom surface 11b1 in the waveguide including the core 12B. That is, in the third embodiment too, the optical waveguide sensor 10C (10) includes two waveguides having different amounts of leakage of the evanescent light from the corresponding bottom surfaces 11b1. Thus, in the third embodiment, if the lengths over which the cores 12A and 12B overlap with the corresponding bottom surfaces 11b1 are treated as the parameters x, regression analysis can be performed in an identical manner to the first embodiment as illustrated in FIG. 4. Alternatively, the projected areas of the cores 12A and 12B onto the corresponding bottom surfaces 11b1 in the Z direction can be treated as the parameters x. That is, the values of multiplication of the length and the width of the cores 12A and 12B can be treated as the parameters x.

In this way, in the third embodiment too, the optical waveguide sensor 10C (10) includes two waveguides (first waveguides) that have different amounts of leakage of the evanescent light from the corresponding bottom surfaces 11b1 (contact surfaces). Thus, in the third embodiment too, as a result of measuring the loss intensity in each of the two waveguides having different amounts of leakage of the evanescent light, the examination of the examination subject S can be performed with more accuracy as compared to the case of measuring the loss intensity in only a single waveguide.

Moreover, in the third embodiment, the bottom surfaces 11b1 are wider on account of including the first areas A1 and the second areas A2. When the recesses 11b are narrow in width, the examination subject S that is relatively harder cannot be examined. As a result, the examination subject S cannot easily enter into the recess 11b and cannot make contact with the bottom surface 11b1. In other words, when the recesses 11b are narrow in width, the examination subject S that can be examined gets confined to an object having fluidity or flexibility so that the object can enter into the recess 11b and can make contact with the bottom surface 11b1. In that regard, in the third embodiment, since the recesses 11b are wide, even the examination subject S having less fluidity or less flexibility can make contact with the bottom surface 11b1, and by extension can make contact with that area of the bottom surface 11b1 from which the evanescent light leaks (in the third embodiment, mainly the first areas A1). Hence, such an examination subject S can also be examined. Herein, the first areas A1 represent examples of a contact surface. Meanwhile, in the third embodiment, since the shape of the recesses 11b is simplified, sometimes it becomes possible to reduce the time and the cost required in manufacturing the optical waveguide sensor 10C.

### Fourth Embodiment

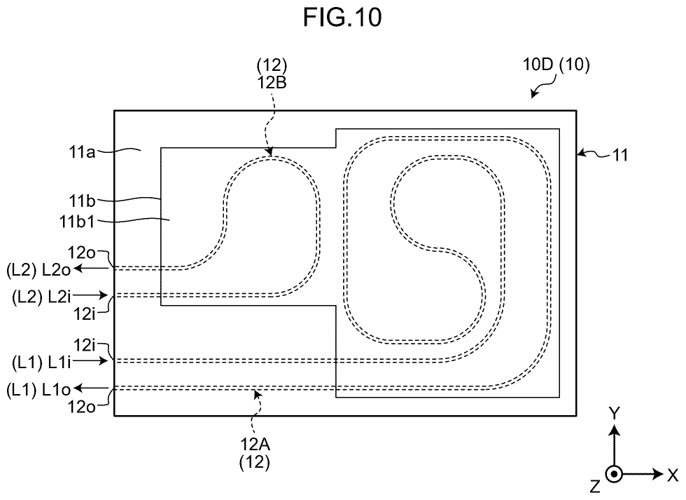

FIG. 10 is a planar view diagram of an optical waveguide sensor 10D (10) according to a fourth embodiment. In the optical waveguide sensor 10D according to the fourth embodiment, a single recess 11b is formed. The recess 11b is formed when the cladding 11 between the two recesses 11b formed in the optical waveguide sensor 10C according to the third embodiment is removed and the two recesses 11b are integrated. Other than that, the optical waveguide sensor 10D has an identical configuration to the optical waveguide sensor 10C according to the third embodiment.

According to the fourth embodiment too, it becomes possible to achieve the same effects as the effects achieved according to the third embodiment. Moreover, according to the fourth embodiment, as a result of achieving further simplification in the shape of the recess 11b, sometimes it becomes possible to further reduce the time and the cost required in manufacturing the optical waveguide sensor 10D.

### Fifth Embodiment

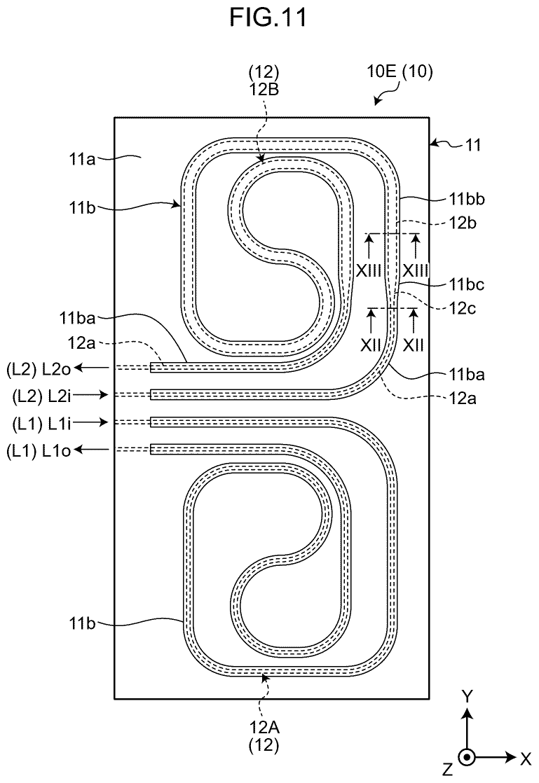

FIG. 11 is a planar view diagram of an optical waveguide sensor 10E (10) according to a fifth embodiment. The optical waveguide sensor 10E according to the fifth embodiment has a partially identical configuration to the optical waveguide sensor 10B (see FIG. 5). More particularly, the core 12A according to the fifth embodiment has the same shape as the core 12A according to the second embodiment. Moreover, in the planar view, the core 12B according to the fifth embodiment extends in the same shape as the core 12B according to the second embodiment. However, in the fifth embodiment, the core 12B includes a plurality of sections having different widths. More particularly, the core 12B includes a first section 12a having a narrow width, a second section 12b that is wider than the width of the first section 12a, and a third section 12c that undergoes gradual variation in the width along the longitudinal direction in between the first section 12a and the second section 12b. The recess 11b includes a narrow-width portion 11ba corresponding to the first section 12a, a wide portion 11bb corresponding to the second section 12b, and an intermediate portion 11bc corresponding to the third section 12c.

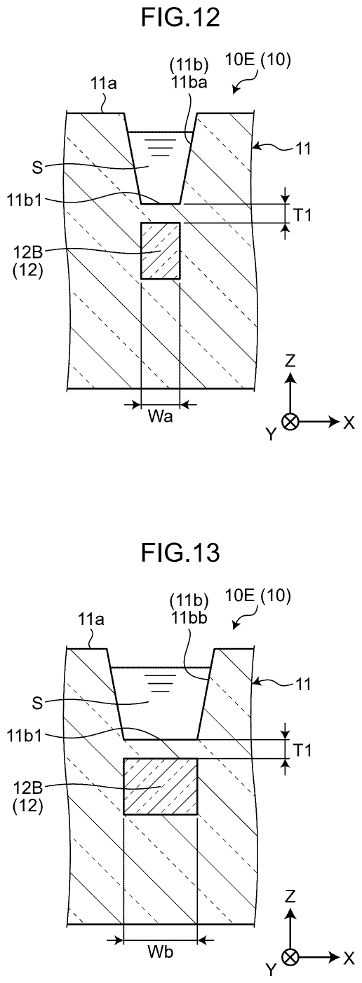

FIG. 12 is an XII-XII cross-sectional view of the optical waveguide sensor 10E illustrated in FIG. 11, and FIG. 13 is an XIII-XIII cross-sectional view of the optical waveguide sensor 10E. As illustrated in FIGS. 12 and 13, the recess 11b is positioned to overlap with the core 12B in the Z direction, and extends along the core 12B. The depth of the recess 11b is constant regardless of the position of the core 12B, and is same as the depth of the recess 11b corresponding to the core 12A. Hence, the thickness T1 between the core 12B and the corresponding bottom surface 11b1 is constant across all sections of the recess 11b, and is same as the thickness T1 between the core 12A and the corresponding bottom surface 11b1. For example, the thickness T1 is equal to or smaller than 5 [μm]. Hence, the evanescent light leaks from the substantially entire bottom surface 11b1 of the recess 11b corresponding to the core 12B. Meanwhile, the bottom surface 11b1 of the recess 11b corresponding to the core 12B substantially overlaps with the core 12B in the Z direction. That is, the width of the bottom surface 11b1 of the narrow-width portion 11ba and the width of the bottom surface 11b1 of the wide portion 11bb are substantially same as a width Wa and a width Wb of the corresponding core 12B, respectively, and changes according to the variation occurring in the width Wa and the width Wb of the core 12B, respectively.

In that case, the area of the bottom surface 11b1 corresponding to the core 12B becomes greater than the area of the bottom surface 11b1 corresponding to the core 12A. Thus, the amount of leakage of the evanescent light from the bottom surface 11b1 in the waveguide including the core 12B becomes greater than the amount of leakage of the evanescent light from the bottom surface 11b1 in the waveguide including the core 12A. That is, in the fifth embodiment too, the optical waveguide sensor 10E (10) includes two waveguides having different amounts of leakage of the evanescent light from the corresponding bottom surfaces 11b1. Thus, in the fifth embodiment, by treating the areas of the bottom surfaces 11b1 as the parameters x, regression analysis can be performed in an identical manner to the first embodiment as illustrated in FIG. 4.

In this way, in the fifth embodiment too, the optical waveguide sensor 10E (10) includes two waveguides (first waveguides) that have different amounts of leakage of the evanescent light from the corresponding bottom surfaces 11b1 (contact surfaces). Thus, in the fifth embodiment too, as a result of measuring the loss intensity in each of the two waveguides, the examination of the examination subject S can be performed with more accuracy as compared to the case of measuring the loss intensity in only a single waveguide.

### Sixth Embodiment

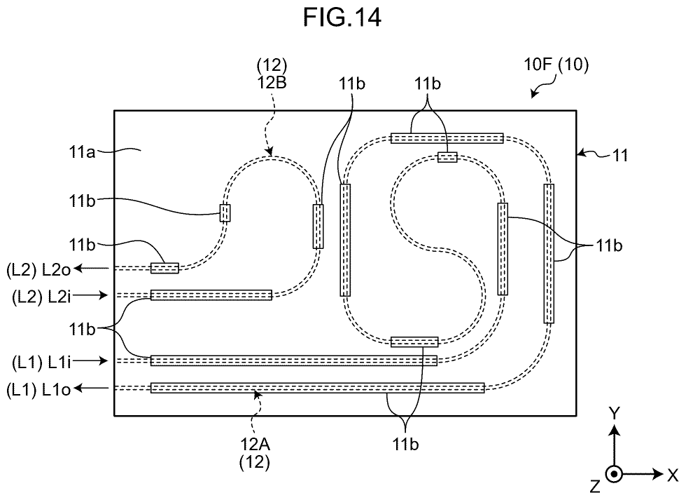

FIG. 14 is a planar view diagram of an optical waveguide sensor 10F (10) according to a sixth embodiment. When FIG. 14 is compared with FIG. 1, it is clear that the cores 12A and 12B (12) of the optical waveguide sensor 10F according to the sixth embodiment have the same shape as the cores 12A and 12B of the optical waveguide sensor 10A according to the first embodiment. However, in the sixth embodiment, in each of the cores 12 and 12B, the recesses 11b are provided at a plurality of positions in a dispersed manner. Each recess 11b has an identical cross-sectional shape as the shape according to the first embodiment (see FIG. 3), extends along the corresponding core from among the cores 12A and 12B, and has a constant width. Moreover, the cores 12A and 12B include straight sections extending in a linear manner in the planar view and include curved sections that are curved in the planar view. From among the straight sections and the curved sections, the recesses 11b are formed corresponding to only the straight sections. The total length of the recesses 11b corresponding to the core 12A is greater than the total length of the recesses 11b corresponding to the core 12B. The bottom surface 11b1 (see FIG. 3) of each recess 11b represents an example of a contact surface and represents an example of a first contact surface. Meanwhile, the recesses 11b need not be formed in all straight sections.

In the sixth embodiment too, the evanescent light leaks from the bottom surface 11b1 of each recess 11b. Thus, in the sixth embodiment too, the optical waveguide sensor 10F (10) includes two waveguides (first waveguides) that have different amounts of leakage of the evanescent light from the corresponding bottom surfaces 11b1 (contact surfaces). Thus, in the sixth embodiment too, as a result of measuring the loss intensity in each of the two waveguides, the examination of the examination subject S can be performed with more accuracy as compared to the case of measuring the loss intensity in only a single waveguide.

Moreover, in the curved sections of the cores 12A and 12B, sometimes there is an increase in the leakage of the evanescent light due to the curved shape. Accompanying such increase, there is a risk of a decline in the examination accuracy. In that regard, according to the sixth embodiment, it becomes possible to eliminate the impact of the leakage of the evanescent light occurring due to the curved shape of the curved sections. As a result, the examination of the examination subject S can be performed with greater accuracy. In other words, according to the sixth embodiment, in each of the cores 12A and 12B (12), a plurality of bottom surfaces 11b1 (contact surfaces) can be placed at favorable positions in a dispersed manner. As a result, the examination accuracy can be enhanced while securing the amount of leakage of the evanescent light required for the examination. Seventh embodiment

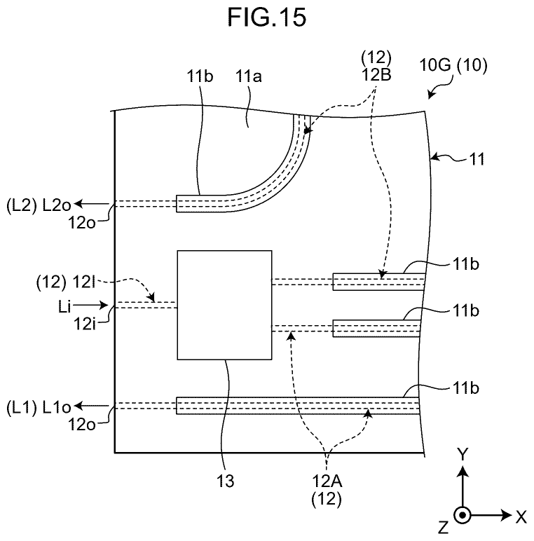

FIG. 15 is a planar view diagram of some part of an optical waveguide sensor 10G (10) according to a seventh embodiment. The configuration according to the seventh embodiment can be substituted for the configuration in the vicinity of the inlet end 12i and the outlet end 120 of the cores 12A and 12B (12) of the optical waveguide sensor 10A according to the first embodiment.

The optical waveguide sensor 10G according to the seventh embodiment includes a branching portion 13. The branching portion 13 branches an examination light L1, which is input from the inlet end 12i of a core 121 (12), to the two cores 12A and 12B. The core 12I represents an example of a core of a second waveguide.

The branching portion 13 can be configured as, for example, a splitter. In that case, examples of the branching portion 13 include a power splitter, a wavelength division multiplexing (WDM) splitter, a polarization beam splitter, and a variable beam splitter.

When the branching portion 13 is a power splitter, it splits the examination light Li to the core 12A and 12B at the already-set intensity ratio (for example, 1:1).

When the branching portion 13 is a WDM splitter, it splits the examination light Li to the cores 12A and 12B for each different wavelength band. In that case, for each different wavelength band, the absorption property of the examination subject S can be examined according to the loss intensity I in each of the cores 12A and 12B.

When the branching portion 13 is a polarization beam splitter, it splits the examination light Li into the transverse electric (TE) polarization component and the transverse magnetic (TM) polarization component. In that case, for each polarization component, the absorption property of the examination subject S can be examined according to the loss intensity I in each of the cores 12A and 12B.

When the branching portion 13 is a variable beam splitter, it can variably set the intensity ratio to be used in splitting the examination light Li to the cores 12A and 12B.

Moreover, the branching portion 13 can be configured as, for example, an optical switch. In that case, the branching portion 13 can selectively input the examination Li to either the core 12A or the core 12B in a time-sharing manner. The optical switch represents an example of a switch.

In either case, in the optical waveguide sensor 10G (10), as a result of including the branching portion 13, the number of light sources can be reduced as compared to the case in which the branching portion 13 is not included. Moreover, a variety of examinations can be performed using a relatively simpler configuration.

### Eighth Embodiment

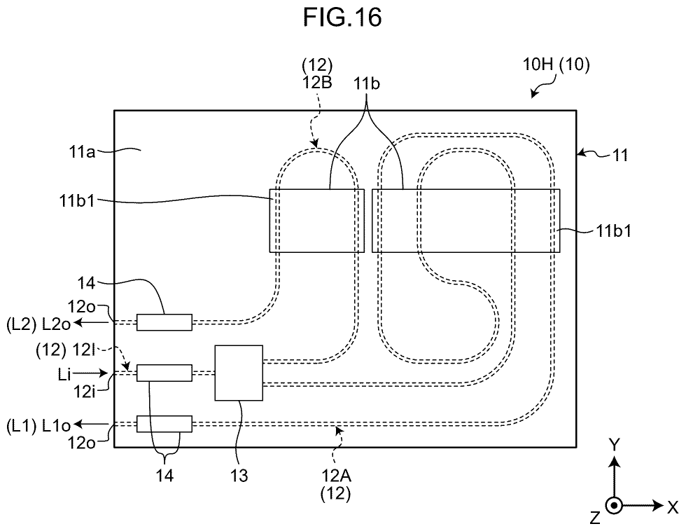

FIG. 16 is a planar view diagram of an optical waveguide sensor 10H (10) according to an eighth embodiment. As illustrated in FIG. 16, the optical waveguide sensor 10H according to the eighth embodiment includes the branching portion 13 (see FIG. 13) identical to the seventh embodiment. Hence, according to the eighth embodiment, it becomes possible to achieve identical effects to the effects achieved according to the seventh embodiment.

In the optical waveguide sensor 10H according to the eighth embodiment, relatively wider recesses 11b (see FIGS. 8 and 9) identical to the third embodiment are formed corresponding to each of the cores 12A and 12B. Hence, according to the eighth embodiment, it is possible to achieve identical effects to the effects achieved according to the third embodiment.

Moreover, according to the eighth embodiment, in an identical manner to the sixth embodiment, the recesses 11b are formed corresponding to the straight sections of the cores 12A and 12B (see FIG. 14). Hence, according to the eighth embodiment, it is possible to achieve identical effects to the effects achieved according to the sixth embodiment.

Moreover, in the eighth embodiment, a mode filter 14 that removes the high-order mode components from the examination light is disposed in each of the cores 12A, 12B, and 121. According to the eighth embodiment, as a result of being able to remove the high-order mode components not required in the examination, the examination accuracy can be further enhanced. The mode filter 14 can be used in the configurations according to the other embodiments too. Meanwhile, the installation positions of the mode filters 14 are not limited to the positions illustrated in FIG. 16.

### Ninth Embodiment

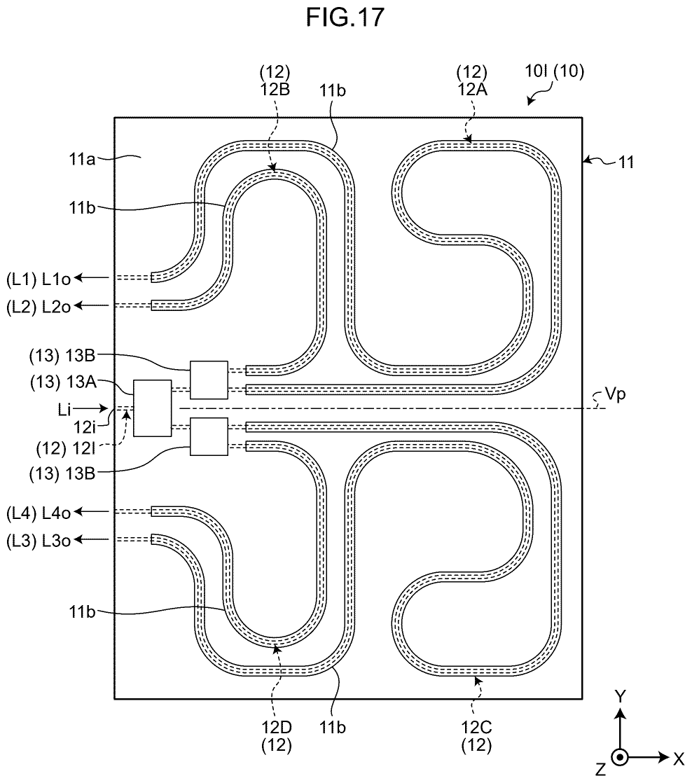

FIG. 17 is a planar view diagram of an optical waveguide sensor 101 (10) according to a ninth embodiment. As illustrated in FIG. 17, the optical waveguide sensor 10I according to the ninth embodiment includes branching portions 13A and 13B (13) and cores 12A, 12B, 12C, 12D, and 12I (12). The examination light Li that is input to the inlet end 12i of the core 121 gets branched via the branching portions 13A and 13B (13).

The cores 12A and 12C are in the mirror image relationship having plane symmetry with respect to the virtual plane Vp that intersects with the Y direction. Similarly, the cores 12B and 12D are in the mirror image relationship having plane symmetry with respect to the virtual plane Vp. Moreover, the recess 11b corresponding to the core 12A and the recess 11b corresponding to the core 12C are in the mirror image relationship having plane symmetry with respect to the virtual plane Vp. Similarly, the recess 11b corresponding to the core 12B and the recess 11b corresponding to the core 12D are in the mirror image relationship having plane symmetry with respect to the virtual plane Vp. Between each of the cores 12A to 12D and the bottom surface 11b1 of the corresponding recess 11b, the thickness T1 (see FIG. 3) is same and remains constant without variation in the longitudinal direction.

The branching portion 13A is, for example, a polarization beam splitter; and the branching portion 13B is, for example, a splitter that splits the light at the intensity ratio of 1:1. In that case, for example, the properties of the examination subject S with respect to the TE polarization component can be examined from the loss intensity I in the waveguides respectively including the cores 12A and 12B; and the properties of the examination subject S with respect to the TM polarization component can be examined from the loss intensity I in the waveguides respectively including the cores 12C and 12D. In this way, as a result of including the branching portions 13, a plurality of properties of the examination subject S can be examined using the examination light Li output from only a single light source. Eventually, sometimes it becomes possible to enhance the examination accuracy regarding the examination subject.

### 10-th Embodiment to 12-th Embodiment

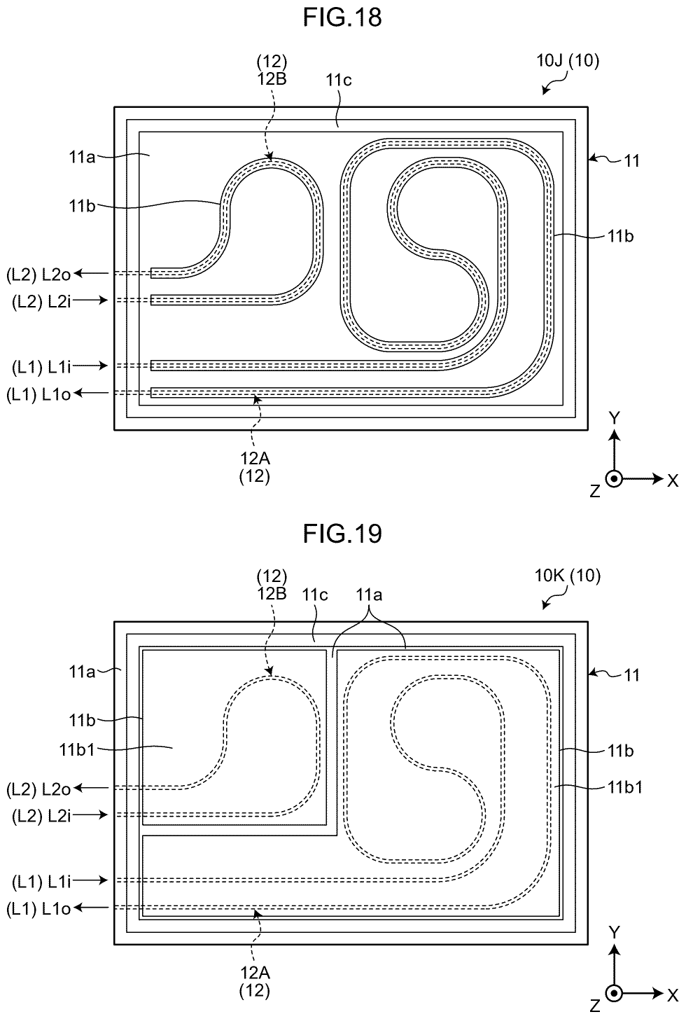

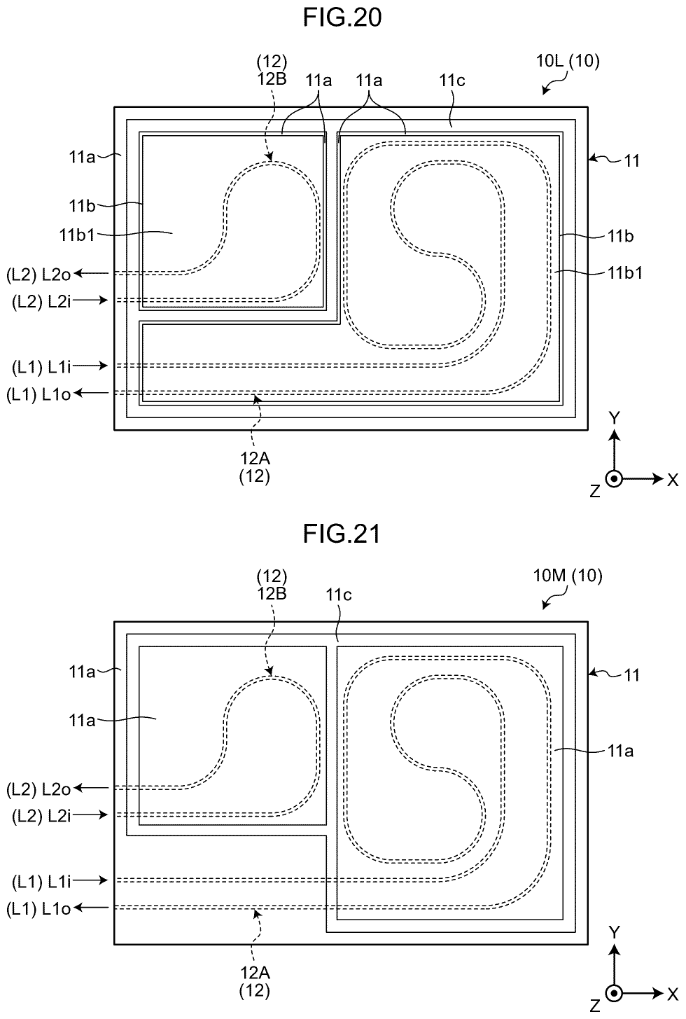

FIG. 18 is a planar view diagram of an optical waveguide sensor 10J (10) according to a 10-th embodiment; FIG. 19 is a planar view diagram of an optical waveguide sensor 10K (10) according to an 11-th embodiment; and FIG. 20 is a planar view diagram of an optical waveguide sensor 10L (10) according to a 12-th embodiment.

As illustrated in FIGS. 18 to 20, the optical waveguide sensors 10J, 10K, and 10L according to the 10-th to 12-th embodiments include the cores 12A and 12B identical to the first embodiment.

As illustrated in FIG. 18, in the optical waveguide sensor 10J according to the 10-th embodiment, the recesses 11b are formed in an identical manner to the first embodiment. Hence, according to the 10-th embodiment, it becomes possible to achieve identical effects to the effects achieved according to the first embodiment.

Moreover, as illustrated in FIGS. 19 and 20, in the optical waveguide sensors 10K and 10L according to the 11-th and 12-th embodiments, respectively; relatively wider recesses 11b (see FIG. 8) are formed corresponding to each of the cores 12A and 12B in an identical manner to the third embodiment. Hence, according to the 11-th and 12-th embodiments, it is possible to achieve identical effects to the effects achieved according to the third embodiment.

Furthermore, as illustrated in FIGS. 18 to 20, in the optical waveguide sensors 10J, 10K, and 10L according to the 10-th to 12-th embodiments, respectively; a groove 11c is formed to enclose the recesses 11b in the planar view. The groove 11c is recessed from the surface 11a in the opposite direction to the Z direction and, for example, extends with a constant depth. However, in the portion passing across at least the cores 12, the depth of the groove 11c is set in such a way that the groove 11c does not reach the cores 12.

If the groove 11c is not formed in the optical waveguide sensors 10J, 10K, and 10L and if the examination subject S is, for example, a liquid; when the examination subject S is poured in excess quantity in the recesses 11b, the examination subject S spills out from the surface 11a of the optical waveguide sensors 10J, 10K, and 10L. In that regard, in the 10-th to 12-th embodiments, since the quantity of the examination subject S exceeding the volume of the recesses 11b gets collected in the groove 11c, the examination subject S can be held down from spilling around the optical waveguide sensors 10J, 10K, and 10L. The groove 11c represents an example of a surrounding recess. As illustrated in FIGS. 18 and 19, the groove 11c either can collectively enclose the recesses 11b and their bottom surfaces 11b1 (see FIG. 3), or can individually enclose each recess 11b and its bottom surface 11b1.

### 13-th Embodiment

FIG. 21 is a planar view diagram of an optical waveguide sensor 10M (10) according to a 13-th embodiment. In the optical waveguide sensor 10M according to the 13-th embodiment, the cores 12A and 12B are disposed in an identical manner to the first embodiment. However, in the optical waveguide sensor 10M, the recesses 11b are not formed corresponding to the cores 12A and 12B. Moreover, between the cores 12A and 12B and the surface 11a, the cladding 11 is configured to have a constant thickness that is relatively thinner such as equal to or smaller than, for example, 5 [μm] in entirety.

Moreover, in the optical waveguide sensor 10M according to the 13-th embodiment, the groove 11c is formed in an identical manner to the 10-th to 12-th embodiments.

As explained above, in the 13-th embodiment, between the cores 12A and 12B and the surface 11a, the thickness of the cladding 11 is relatively thinner. For that reason, of the surface 11a, the evanescent light leaks from the regions overlapping with the cores 12A and 12B in the Z direction, that is, leaks from the elongated regions extending along the cores 12A and 12B, respectively. Thus, when the examination subject S is placed on such a region, the examination can be performed in an identical manner to the first embodiment. In that case, of the surface 11a, the regions overlapping with the cores 12A and 12B in the Z direction represent examples of a contact surface.

In the configuration explained above, in order to perform the examination with accuracy, it is necessary to accurately manage the area of the contact surface corresponding to each of the cores 12A and 12B, that is, the area of each contact surface with which the examination subject S is in contact and on which the evanescent light leaks. In that regard, in the 13-th embodiment, the groove 11c is used in managing the size of the contact surface. More particularly, of the surface 11a, the examination subject S can be placed over the entire region of the inside of the groove 11c for establishing the contact. In that case, of the surfaces 11a, the linear regions overlapping with those sections of the cores 12A and 12B which are enclosed by the groove 11c in the planar view serve as the contact surfaces. Meanwhile, for example, when the examination subject S is a liquid, depending on its surface tension, the entire liquid can be placed in the region enclosed by the groove 11c of the surface 11a. In that case, the liquid that spills out from the region enclosed by the groove 11c gets collected in the groove 11c. The groove 11c represents an example of an identification structure that enables visual identification of the position serving as the contact surface for the user, that is, the position at which the examination subject S is to be placed.

According to the 13-th embodiment, the optical waveguide sensor 10M (10) can be implemented using a simpler configuration. Moreover, because of the groove 11c, the position of placing the examination subject S becomes physically or visually determinable with ease, thereby enabling achieving enhancement in the examination accuracy. Meanwhile, also in a configuration in which the groove 11c is replaced with a wall protruding from the surface 11a in the Z direction, identical effects can be achieved.

### 14-th Embodiment

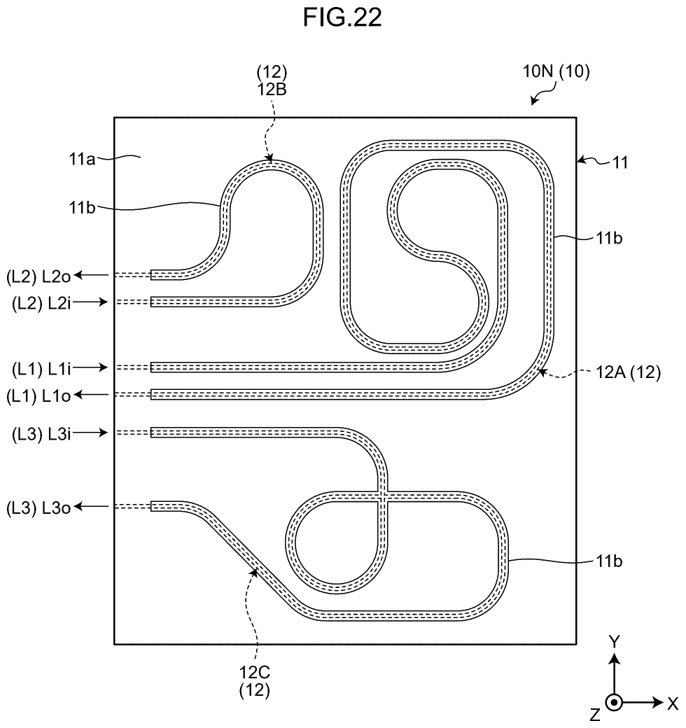

FIG. 22 is a planar view diagram of an optical waveguide sensor 10N (10) according to a 14-th embodiment. In the optical waveguide sensor 10N according to the 14-th embodiment, in addition to including the cores 12A and 12B and the corresponding recesses 11b in an identical manner to the optical waveguide sensor 10A according to the first embodiment, the additional core 12C and the recess 11b corresponding to that core 12C is also included. The core 12C and the recess 11b have the same cross-sectional shape as the first embodiment (see FIG. 3) and, with the cross-sectional shape illustrated in FIG. 3, extend to intersect with the Z direction. An incident light L3i of an examination light L3 is input to the core 12C; and an outgoing light L30 of the examination light L3 is output from the core 12C.

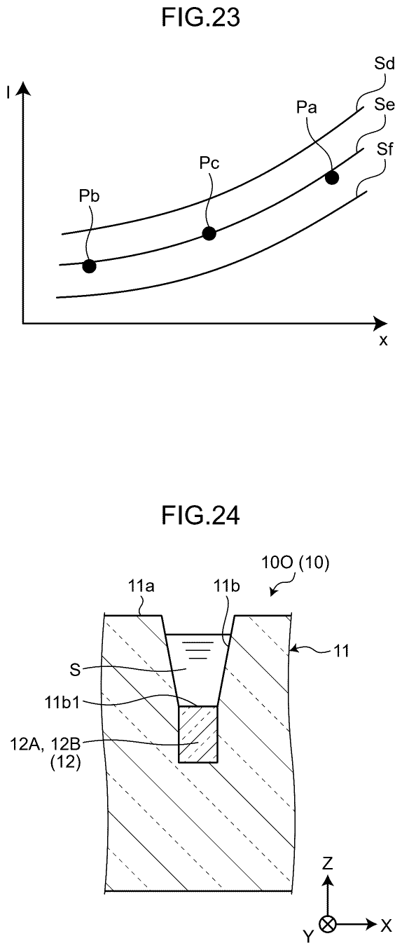

FIG. 23 is a diagram illustrating an example of the regression analysis of the parameter x and the loss intensity I of the detection result obtained by the optical waveguide sensor 10N. In FIG. 23 is illustrated the experiment result corresponding to the same examination lights L1, L2, and L3. In the graph, a point Pa represents the coordinates of the measurement result of the parameter x and the loss intensity I corresponding to the core 12A; a point Pb represents the coordinates of the measurement result of the parameter x and the loss intensity I corresponding to the core 12B; and a point Pc represents the coordinates of the measurement result of the parameter x and the loss intensity I corresponding to the core 12C. In an identical manner to the first embodiment (see FIG. 4), in the 14-th embodiment too, if a function obtained by performing regression analysis of the points Pa, Pb, and Pc is compared with a function of the parameter x and the loss intensity I of each of known materials Sd to Sf, it becomes possible to identify whether the examination subject S is same as any one of the materials Sd to Sf or to figure out the material from among the materials Sd to Sf to which the properties of the examination subject S are close. Meanwhile, in FIG. 23 is illustrated the example in which the parameter x and the loss intensity I are not proportional to each other. Alternatively, the parameter x can be proportional to the loss intensity I. Moreover, the function of the parameter x and the loss intensity I can be of various types.

### Modification Example in Which Cladding Is Absent Between Core and Examination Subject

FIG. 24 is a cross-sectional view, at an equivalent position to FIG. 3, of an optical waveguide sensor 100 according to a modification example of the first embodiment. Except for the configuration illustrated in FIG. 24, the optical waveguide sensor 100 has an identical configuration to the first embodiment. In the surrounding portion of the core 12A as well as the surrounding portion of the core 12B, the optical waveguide sensor 100 has the cross-sectional shape illustrated in FIG. 24, that is, has the identical cross-sectional shape. As illustrated in FIG. 24, the cladding 11 can be absent between the cores 12 and the bottom surfaces 11b1 of the corresponding recesses 11b. Thus, this configuration is obtained when the thickness T1 in the configuration illustrated in FIG. 3 is set to “0”. With this configuration, the evanescent light of the examination lights L1 and L2 can be more reliably leaked onto the examination subject S.

While certain embodiments and modification examples have been described, these embodiments and modification examples have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, regarding the constituent elements, the specifications about the configurations and the shapes (structure, type, direction, shape, size, length, width, thickness, height, number, arrangement, position, material, etc.) can be suitably modified.

For example, the number of cores (waveguides) and the number of recesses can be equal to or greater than four. Moreover, an optical waveguide sensor can include a plurality of waveguides in which the amount of leakage is same. In that case, one of those waveguides can be used as the reference waveguide for the purpose of referring to the loss intensity of an examination subject having known properties.

Furthermore, the structure enabling identification of the contact surface can be in the form of characters or a design.

According to the disclosure, it becomes possible to provide a new and improved optical waveguide sensor that, for example, enables achieving enhancement in the measurement accuracy.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical waveguide sensor comprising:
a plurality of first waveguides, each first waveguide including a core at least partially enclosed by a cladding and being configured to guide an examination light; and
a contact surface with which an examination subject is in contact and from which leaks seeping component of the examination light guided by the first waveguides, wherein
the examination light guided by the plurality of first waveguides has mutually different amount of leakage from the contact surface.

2. The optical waveguide sensor according to claim 1, further comprising:
a first surface that is positioned at an end portion in a first direction; and
a receiving recess that is recessed from the first surface in an opposite direction to the first direction, the receiving recess being configured to receive the examination subject, wherein
the plurality of first waveguides extend to intersect with the first direction, and
the receiving recess has a bottom surface including the contact surface.

3. The optical waveguide sensor according to claim 2, wherein
the receiving recess includes a plurality of first recesses, and
the bottom surface of each of the first recesses includes the contact surface present between a different first waveguide and the examination subject.

4. The optical waveguide sensor according to claim 2, wherein the bottom surface includes
a first region that overlaps with the core in the first direction, and
a second region that does not overlap with the core in the first direction and that is positioned adjacent to the first region.

5. The optical waveguide sensor according to claim 1, wherein the contact surface includes a plurality of first contact surfaces.

6. The optical waveguide sensor according to claim 1, comprising an identification structure that enables visual identification of the contact surface.

7. The optical waveguide sensor according to claim 1, further comprising:
a first surface that is positioned at an end portion in a first direction; and
a surrounding recess that is around the contact surface and that is recessed from the first surface in an opposite direction to the first direction.

8. The optical waveguide sensor according to claim 1, wherein the first waveguides have mutually different lengths.

9. The optical waveguide sensor according to claim 1, wherein the first waveguides have mutually different widths.

10. The optical waveguide sensor according to claim 1, wherein the first waveguides have mutually different distances between the core and the contact surface.

11. The optical waveguide sensor according to claim 1, further comprising:
a second waveguide configured to guide the examination light; and
a splitter configured to branch the examination light from the second waveguide to the first waveguides.

12. The optical waveguide sensor according to claim 1, further comprising:
a second waveguide configured to guide the examination light; and
a switch configured to guide the examination light from the second waveguide to the first waveguides in a selective manner.

13. The optical waveguide sensor according to claim 1, further comprising a mode filter configured to remove a high-order mode component from the examination light.

14. The optical waveguide sensor according to claim 1, wherein the first waveguides extend in a curved manner.

15. The optical waveguide sensor according to claim 1, wherein
the first waveguides include
a straight section that extends in a linear manner and intersects with the first direction, and
a curved section that extends in a curved manner and intersects with the first direction, and
the contact surface is provided corresponding to only the straight section in the straight section and the curved section.

16. The optical waveguide sensor according to claim 1, wherein the optical waveguide sensor is made of a material containing SiO₂.

17. An optical waveguide sensor comprising:
a plurality of first waveguides, each first waveguide including a core at least partially enclosed by a cladding and being configured to guide an examination light; and
a contact surface with which an examination subject is in contact and from which leaks seeping component of the examination light guided by the first waveguides, wherein
the contact surface includes a first contact surface corresponding to each of the first waveguides.

18. An optical waveguide sensor comprising:
a plurality of first waveguides, each first waveguide including a core at least partially enclosed by a cladding and being configured to guide an examination light;
a contact surface with which an examination subject is in contact and from which leaks seeping component of the examination light guided by the first waveguides; and
an identification structure that enables visual identification of the contact surface.
